(19) United States
(12) Patent Application Publication
(10) Pub. No.: US 2009/0299884 A1
(43) Pub. Date: Dec. 3, 2009

(54) REMOTE SYSTEM UPGRADES IN SPECIFIC REGULATORY ENVIRONMENTS

(75) Inventor: Subhas Chandra, Mississauga (CA)

Correspondence Address: DORITY & MANNING, P.A., POST OFFICE BOX 1449, GREENVILLE, SC, 29602-1449, US

(73) Assignee: Itron, Inc., Liberty Lake, WA (US)

(21) Appl. No.: 12/472,932

(22) Filed: May 27, 2009

Related U.S. Application Data
(60) Provisional application No. 61/057,608, filed on May 30, 2008.

(51) Int. Cl. G06Q 30/00; G06Q 50/00

(52) U.S. Cl. 705/34; 705/412

(57) ABSTRACT

Disclosed are apparatus and methodology for providing remote system upgrades to utility meters in certain regulatory environments. A utility meter having a metrology section and a registry portion is provided with additional memory in the metrology section, and configured as the primary storage location for billing information. The metrology section is configured for remote upgrade of firmware associated with automatic meter reading (AMR) functions in a manner that maintains the integrity of stored billing material despite any failed upgrade of the associated AMR device or functionality

### PRIORITY CLAIM

This application claims the benefit of previously filed U.S. Provisional Patent Application entitled “Remote System Upgrades In Specific Regulatory Environments,” assigned U.S. Ser. No. 61/057,608, filed May 30, 2008, and which is incorporated herein by reference for all purposes.

### FIELD OF THE INVENTION

The present disclosure relates generally to metrology, and in particular, relates to metrology for use in a residential single phase environment.

### BACKGROUND OF THE INVENTION

Electricity meters used for billing purposes typically must accommodate local or regional regulatory requirements, if any, particular to the area in which they are used. For example, electricity meters used for legal billing in Canada must meet specific requirements and be “approved” by Measurement Canada (hereinafter also referenced as “MC”). Once approved, the meter design must remain true to the “approved type”, meaning that any change to the hardware, software, or packaging, must be submitted to MC for re-approval. Except for a lengthy turn-around time, the approval of running changes to production meters is typically straightforward. However, such is not typically the case for so-called in-service modifications.

Whenever the desired in-service modification is intended to be the associated hardware, not much efficiency can be expected because the devices must be un-sealed (meaning that literally a physical seal is broken), repaired, re-verified and re-sealed. In-service modification to firmware is only presently being addressed by MC while otherwise a transition procedure is relied on, based, in part, on previously established directives.

In general, it is understood that an electricity meter typically includes a metrology section and a separate register section. Such register can be a memory location or a visual display. Whenever a memory location is practiced, there must be a facility (a hand held device or laptop, or PC) to make the content of such memory location available to the meter owner. As the feature set of the meter increases, the register section typically becomes more complex because it must be able to perform more operations and to store more information. Feature sets may include such as Time of Use, Load Profile, Demand, Four Quadrant Metering, Power quality, and more, all as generally well known to those of ordinary skill in the art without requiring additional discussion herein. With the addition of Automated Meter Reading (AMR) features, the register subsystem, depending on its design, may become even more complex.

With complexity comes reliability issues and increased probability of glitches bugs. In addition to metering and registering, the device typically must be designed to detect tampering, including unauthorized modification to any of its parts. Particularly in Canada, the registration which is resident in the meter is the legal quantity used for billing, and if an AMR system is in use, there must be periodic checks to ensure that the meter data and the data retrieved by the AMR are in synch.

As Register/AMR systems became more complex and as regular in-service upgrades became reality, it has become necessary to address the restrictions on in-service modifications that are in place in a regulated environment (for example, Measurement Canada jurisdiction). It would, therefore, be desirable to develop a methodology and corresponding apparatus wherein billing data may be safely stored, yet firmware also upgraded (or upgradeable) in a manner that does not impact stored billing data.

While various implementations of metrology systems have been developed, and while various combinations of data storage and firmware upgrade capabilities have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved methodology (and corresponding apparatus) for remote system upgrades and secure storage of billing data in metrology systems has been developed.

In an exemplary configuration, the metrology and register subsystems of an electricity meter are separated so as to qualify the device for in-service firmware update of the Register/AMR system; however, the revised firmware has to be evaluated by the legally controlling metrology lab (an MC facility, for example, in Canada) to ensure that metrology was not affected by the upgrade, before the field upgrade can take place. Such evaluation process can take from two to six weeks, or more. To avoid such an evaluation, in accordance with present technology, a second set of registers located in the metrology section of the meter has been introduced. Historically, the metrology section of an electricity meter is the most stable section of the meter, and the one least likely to require an in-service modification.

In one of its simpler forms, the metrology and register/AMR (automatic meter reading) board pair is configured such that register/AMR firmware may be upgraded via AMI network downloads or local in-service download such as by a handheld device without putting the register/billing information at risk in the event of a failure in the download process.

Another positive aspect of such present type of device is that, in the event that the download process should render the register/AMR useless, the billing information can be recovered from the metrology section (or board) because any failed upgrade of the attached AMR device does not interfere with the integrity of the billing data (which is separately stored).

Considered in other terms, the present disclosure relates to metrology, in particular metrology for use in a residential single phase environment. In accordance with the present subject matter, billing data, that is, the data conventionally saved in the meter register by way of separate memory or, as represented in older meters, as a visual display on the meter face, is instead stored on the metrology board as a primary storage for such data before being transmitted to a Register/AMR board and then on to a central facility for bill presentation purposes.

In still further aspects of the present subject matter, the metrology and Register/AMR board pair is configured such that Register/AMR board firmware may be upgraded via AMI network download or local in-service download (such as through use of a handheld device) without putting the register/billing information at risk in the event of a failure in the download process. Should the download event render the Register/AMR useless, the billing information can be recovered from the metrology section (or board). Such form of storage of billing data has been previously employed in polyphase environments. However, in such environments, inherently any failed upgrade of an attached AMR device does not interfere with the integrity of the billing data, because such is stored separately in the polyphase meter's register.

Present subject matter is applicable in the residential single phase environment, where the AMR functionality depends on the base metrology for real time consumption information but not for storage. Such present subject matter, wherein the billing information is held in the metrology section, is a departure in that regard from such prior practices. The resulting residential single phase meter of the present subject matter advantageously is qualified for sealing of the base, and in combination with a Register/AMR board or system, provides for stored data and AMI-enabled firmware download capability.

One exemplary embodiment of the present subject matter relates to methodology for providing remote system upgrades to electricity meters in regulated residential single phase environments, for making in-service modifications to such meters while maintaining the integrity of billing data stored therein. Such methodology may preferably comprise providing a plurality of electricity meters, each having automatic meter reading (AMR) functionality, and each directly or indirectly associated with a communications link for respectively forwarding billing data to a billing center for processing of such billing data; providing each of the electricity meters with respective metrology sections and separate register sections, each such metrology section having primary billing data memory configured to serve as the primary storage location for billing data determined by the associated electricity meter, each such register section having transferred billing data memory configured to receive billing data transferred thereto from its respectively associated metrology section memory, and each such electricity meter being configured for remote upgrade of automatic meter reading (AMR) functionality thereof while maintaining the integrity of stored billing data therein, despite any failed upgrade attempt; conducting an in-service modification to one or more targeted meters of such plurality of electricity meters; and subsequent to an upgrade or an attempted upgrade of such targeted meters, respectively forwarding billing data from the metrology sections of such targeted meters to the respective register sections thereof, for reporting to the billing center without loss of billing data integrity during any in-service modifications or attempted modifications to such targeted meters.

In certain variations of such exemplary methodology, the in-service modification may comprise an in-service firmware update of the Register/AMR system of such meter; and the register section transferred billing data memory may include one of a memory location in such section or a visual display associated with the electricity meter.

Further in conjunction with certain variations of embodiments of such present methodology, the register section transferred billing data memory may include a memory location in such section; and such method may further include using one of a handheld device, a laptop, or PC to make the billing data content of such memory location available to the meter owner.

In given embodiments, the foregoing methodology may further include performing periodic checks to ensure that meter billing data and data retrieved via the AMR functionality are in synch. In other instances, variations may involve determining that an in-service modification has failed for a targeted meter; and using billing data recovered from the metrology section of such determined meter for forwarding to the register section thereof.

Another present exemplary methodology for providing remote system upgrades to utility meters in regulated residential environments, for making in-service modifications to such meters while maintaining the integrity of billing data stored therein, may comprise providing a plurality of utility meters, each having automatic meter reading (AMR) functionality for respectively forwarding billing data to a billing center; and providing each of the utility meters with respective metrology sections and separate register sections, each such metrology section having additional memory configured to serve as the primary storage location for billing data determined by the associated utility meter. In such arrangements, preferably each such meter may be configured for remote upgrade of automatic meter reading (AMR) functionality thereof while maintaining the integrity of stored billing data in the metrology section additional memory thereof, despite any failed upgrade attempt.

Variations of the foregoing may further include conducting an in-service modification to one or more targeted meters of such plurality of utility meters; and subsequent to an upgrade or an attempted upgrade of such targeted meters, respectively forwarding billing data from the metrology sections of such targeted meters to the respective register sections thereof, for reporting to the billing center without loss of billing data integrity during any in-service modifications or attempted modifications to such targeted meters.

In given of the foregoing exemplary methodologies, the register section may include one of a memory location in such section or a visual display associated with the utility meter; the in-service modification may comprise an in-service firmware update of the Register/AMR system of such meter; and such methodology may further include replacing as necessary a register section of an electricity meter in an on-site operation without requiring recertification of the separate metrology section of such electricity meter, and without loss of billing data therefrom. Also, the register section may include a memory location in such section; and the method may further include using one of a handheld device, a laptop, or PC to make the billing data content of such memory location available to the meter owner.

In other variations of such methodology, periodic checks may be performed to ensure that meter billing data and data retrieved via the AMR functionality are in synch; and determinations may be made that an in-service modification has failed for a targeted meter, followed by using billing data recovered from the metrology section of such determined meter for forwarding to the register section thereof.

Those of ordinary skill in the art will understand that the present subject matter encompasses both methodology and corresponding apparatus.

In another present exemplary embodiment in accordance with the present subject matter, an electricity meter may be adapted for use in regulated residential single phase environments, for enabling in-service modifications to such meter while maintaining the integrity of billing data stored therein. Such an exemplary present meter may include an electricity meter having automatic meter reading (AMR) functionality, and configured for one of direct or indirect association with a communications link for respectively forwarding billing data from such meter to a billing center for processing of such billing data; and a respective metrology section and separate register section in such electricity meter, such metrology section having primary billing data memory configured to serve as the primary storage location for billing data determined by such electricity meter, and such register section having transferred billing data memory configured to receive billing data transferred thereto from such meter metrology section memory. Preferably, such present electricity meter may be further configured for remote upgrade of automatic meter reading (AMR) functionality thereof while maintaining the integrity of stored billing data therein, despite any failed upgrade attempt.

In variations of the foregoing, such electricity meter may be configured for remote in-service modification comprising an in-service firmware update of the Register/AMR system of such meter. Still further, in certain embodiments, such register section transferred billing data memory may comprise one of a memory location in such section or a visual display associated with such electricity meter; and such register section of such electricity meter may be configured to be replaced in an on-site operation without requiring recertification of the separate metrology section of such electricity meter, and without loss of billing data therefrom. Further, in some instances, such electricity meter may be configured for performing periodic checks as part of ensuring that meter billing data and data retrieved via the AMR functionality are in synch. In other instances, such electricity meter may be configured for determining that an in-service modification has failed, and for using billing data recovered from such metrology section thereof for forwarding to such register section thereof, and for subsequently forwarding such transferred billing data from such register section to an associated billing center.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, which encompasses full and enabling disclosure of the present subject matter, including the best mode thereof, directed to one of ordinary skill in the art.

### BRIEF DESCRIPTION OF THE DRAWINGS

A full and enabling disclosure of the present subject matter, including the best mode thereof, directed to one of ordinary skill in the art, is set forth in the specification, which makes reference to the appended FIGURE, in which:

FIG. 1 illustrates in block diagram format both exemplary apparatus and corresponding methodology for practice in exemplary embodiments of the present subject matter.

Repeat use of reference characters throughout the present specification and appended drawing materials is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with methodology (and corresponding apparatus) for remote system upgrades in combination with secure storage of billing data in metrology systems.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

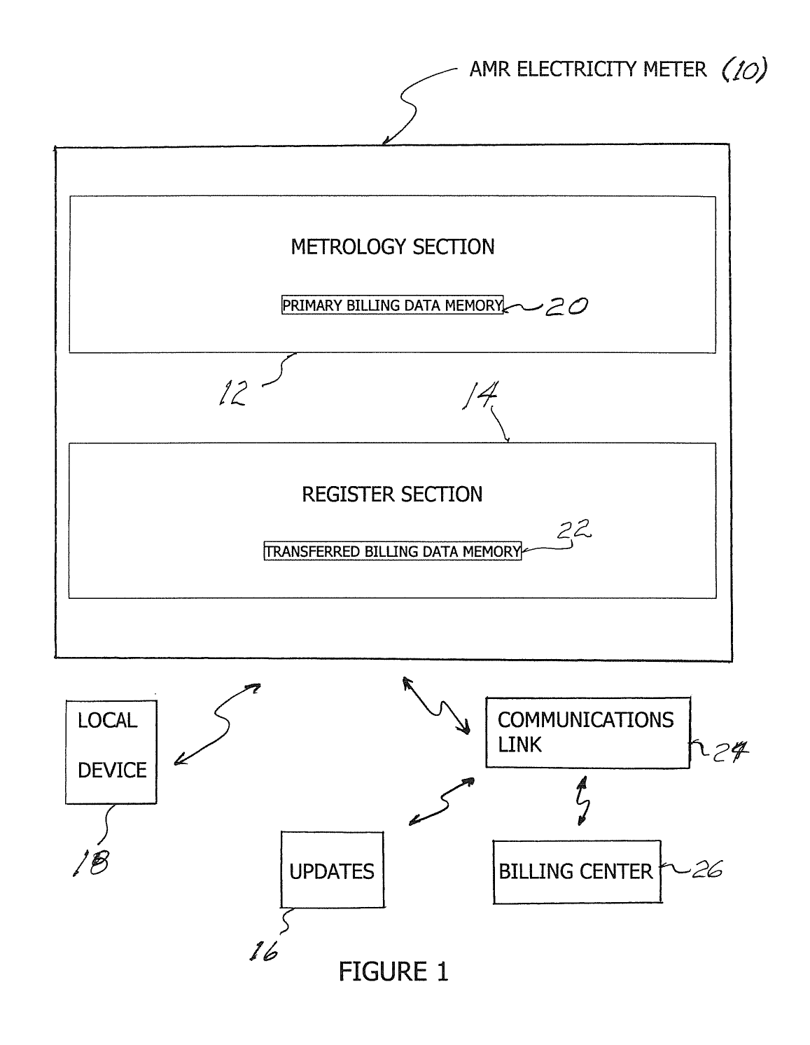

Reference will now be made in detail to the presently preferred embodiments of the subject remotely upgradeable metrology system, also with reference to present FIG. 1. In an exemplary utility meter generally 10 in accordance with present technology, there is provided a metrology board or section generally 12, and, separately, a register board or section generally 14. The metrology board includes mechanisms where on-board firmware may be upgraded, either by way of AMI networking downloads (represented generally by “updates” 16) or by onsite use of handheld devices (such as representative “local device” 18).

In accordance with one aspect of the present technology, the metrology board has been augmented by provision of an associated memory generally 20 configured to function as the primary storage for billing data. When safe to do so, billing data may be moved from memory 20 into a transferred billing data memory 22 in register section 14, in ready for passage via a communications link generally 24 to a billing center generally 26. Such configuration of memory 20 within metrology section 12 is contrary to otherwise known configurations wherein billing data has heretofore been stored in a separate register or display portion of utility meters of the type here contemplated.

In accordance with present technology, the additional storage associated with the metrology board is configured such that the AMR features associated with the metrology functions of the utility meter may be upgraded while insuring the safe storage of any billing data, despite any failure of an attempted upgrade to the AMR firmware.

As intended to be understood by those of ordinary skill in the art from the complete disclosure herewith, practice of the present methodology (and corresponding apparatus) for providing remote system upgrades to electricity meters in regulated residential single phase environments, provides for making in-service modifications to such meters while maintaining the integrity of billing data stored therein. In one exemplary embodiment, a plurality of electricity or other meters generally such as meter 10 may be provided. Each such meter is provided with automatic meter reading (AMR) functionality, the details of which are not encompassed by the present subject matter. Each meter may directly or indirectly be associated with a communications link for respectively forwarding billing data to a billing center for processing of such billing data, again the details of which are well understood by those of ordinary skill in the art, and which do not form particular aspects of the present subject matter.

Still per present subject matter, each of such electricity meters generally 10 may be provided with respective metrology sections generally 12 and separate register sections generally 14, each such metrology section having primary billing data memory generally 20 configured to serve as the primary storage location for billing data determined by the associated electricity meter, and with each such register section having transferred billing data memory 22 configured to receive billing data transferred thereto from its respectively associated metrology section memory, and each such electricity meter being configured for remote upgrade of automatic meter reading (AMR) functionality thereof while maintaining the integrity of stored billing data therein, despite any failed upgrade attempt. With such technology, an in-service modification may be conducted, directed to one or more targeted meters of such plurality of electricity meters.

Further, per present technology, subsequent to an upgrade or an attempted upgrade of such targeted meters, billing data may be respectively forwarded from the metrology sections of such targeted meters to the respective register sections thereof, for reporting to the billing center without loss of billing data integrity during any in-service modifications or attempted modifications to such targeted meters.

An in-service modification may comprise an in-service firmware update of the Register/AMR system of such meter, or some other update.

In other present variations, the register section transferred billing data memory may include one of a memory location in such section or a visual display associated with the electricity meter. When the register section transferred billing data memory includes a memory location present methodology may further include using one of a handheld device, a laptop, or PC to make the billing data content of such memory location available to the meter owner, all as represented by local device 18.

Other aspects of the present methodology to be understood from the present disclosure involves performing periodic checks to ensure that meter billing data and data retrieved via the AMR functionality are in synch. Another option of the present methodology is determining that an in-service modification has failed for a targeted meter; and using billing data recovered from the metrology section of such determined meter for forwarding to the register section thereof.

An additional aspect to the present technology resides in the improved capability of onsite service of the utility meter without having to actually “pull” the meter for recertification if the seals normally provided must be removed for service. By providing storage for billing data within the metrology section of the meter, it is now possible to replace the registry board or section 14, if necessary, without fear of loss of any stored billing data or need for recertification of the meter, as previously may have been required.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. Methodology for providing remote system upgrades to electricity meters in regulated residential single phase environments, for making in-service modifications to such meters while maintaining the integrity of billing data stored therein, comprising:
providing a plurality of electricity meters, each having automatic meter reading (AMR) functionality and each directly or indirectly associated with a communications link for respectively forwarding billing data to a billing center for processing of such billing data;
providing each of the electricity meters with respective metrology sections and separate register sections, each such metrology section having primary billing data memory configured to serve as the primary storage location for billing data determined by the associated electricity meter, each such register section having transferred billing data memory configured to receive billing data transferred thereto from its respectively associated metrology section memory, and each such electricity meter being configured for remote upgrade of automatic meter reading (AMR) functionality thereof while maintaining the integrity of stored billing data therein, despite any failed upgrade attempt;
conducting an in-service modification to one or more targeted meters of such plurality of electricity meters; and
subsequent to an upgrade or an attempted upgrade of such targeted meters, respectively forwarding billing data from the metrology sections of such targeted meters to the respective register sections thereof, for reporting to the billing center without loss of billing data integrity during any in-service modifications or attempted modifications to such targeted meters.

2. Methodology as in claim 1, wherein:
the in-service modification comprises an in-service firmware update of the Register/AMR system of such meter; and
the register section transferred billing data memory includes one of a memory location in such section or a visual display associated with the electricity meter.

3. Methodology as in claim 1, wherein:
the register section transferred billing data memory includes a memory location in such section; and
the method further includes using one of a handheld device, a laptop, or PC to make the billing data content of such memory location available to the meter owner.

4. Methodology as in claim 1, further including performing periodic checks to ensure that meter billing data and data retrieved via the AMR functionality are in synch.

5. Methodology as in claim 1, further including:
determining that an in-service modification has failed for a targeted meter; and
using billing data recovered from the metrology section of such determined meter for forwarding to the register section thereof.

6. Methodology for providing remote system upgrades to utility meters in regulated residential environments, for making in-service modifications to such meters while maintaining the integrity of billing data stored therein, comprising:
providing a plurality of utility meters, each having automatic meter reading (AMR) functionality for respectively forwarding billing data to a billing center; and
providing each of the utility meters with respective metrology sections and separate register sections, each such metrology section having additional memory configured to serve as the primary storage location for billing data determined by the associated utility meter;
wherein each such meter is configured for remote upgrade of automatic meter reading (AMR) functionality thereof while maintaining the integrity of stored billing data in the metrology section additional memory thereof, despite any failed upgrade attempt.

7. Methodology as in claim 6, further including:
conducting an in-service modification to one or more targeted meters of such plurality of utility meters; and
subsequent to an upgrade or an attempted upgrade of such targeted meters, respectively forwarding billing data from the metrology sections of such targeted meters to the respective register sections thereof, for reporting to the billing center without loss of billing data integrity during any in-service modifications or attempted modifications to such targeted meters.

8. Methodology as in claim 6, wherein:
the register section includes one of a memory location in such section or a visual display associated with the utility meter;
the in-service modification comprises an in-service firmware update of the Register/AMR system of such meter; and
such methodology further includes replacing as necessary a register section of an electricity meter in an on-site operation without requiring recertification of the separate metrology section of such electricity meter, and without loss of billing data therefrom.

9. Methodology as in claim 6, wherein:
the register section includes a memory location in such section; and
the method further includes using one of a handheld device, a laptop, or PC to make the billing data content of such memory location available to the meter owner.

10. Methodology as in claim 6, further including:
performing periodic checks to ensure that meter billing data and data retrieved via the AMR functionality are in synch; and
determining that an in-service modification has failed for a targeted meter, and using billing data recovered from the metrology section of such determined meter for forwarding to the register section thereof.

11. An electricity meter adapted for use in regulated residential single phase environments, for enabling in-service modifications to such meter while maintaining the integrity of billing data stored therein, comprising:
an electricity meter having automatic meter reading (AMR) functionality, and configured for one of direct or indirect association with a communications link for respectively forwarding billing data from such meter to a billing center for processing of such billing data; and
a respective metrology section and separate register section in said electricity meter, said metrology section having primary billing data memory configured to serve as the primary storage location for billing data determined by said electricity meter, and said register section having transferred billing data memory configured to receive billing data transferred thereto from said meter metrology section memory;
wherein said electricity meter is further configured for remote upgrade of automatic meter reading (AMR) functionality thereof while maintaining the integrity of stored billing data therein, despite any failed upgrade attempt.

12. An electricity meter as in claim 11, wherein said electricity meter is configured for remote in-service modification comprising an in-service firmware update of the Register/AMR system of such meter.

13. An electricity meter as in claim 11, wherein:
said register section transferred billing data memory comprises one of a memory location in such section or a visual display associated with said electricity meter; and
said register section of said electricity meter is configured to be replaced in an on-site operation without requiring recertification of the separate metrology section of said electricity meter, and without loss of billing data therefrom.

14. An electricity meter as in claim 11, wherein said electricity meter is configured for performing periodic checks as part of ensuring that meter billing data and data retrieved via the AMR functionality are in synch.

15. An electricity meter as in claim 11, wherein said electricity meter is configured for determining that an in-service modification has failed, and for using billing data recovered from said metrology section thereof for forwarding to said register section thereof, and for subsequently forwarding such transferred billing data from said register section to an associated billing center.
